(19) United States
(12) Patent Application Publication
(10) Pub. No.: US 2012/0269025 A1
(43) Pub. Date: Oct. 25, 2012

(54) BEVERAGE CONTAINER

(75) Inventor: Sheng-Yu Liu, Taipei City (TW)

(73) Assignee: FREE-FREE INDUSTRIAL CORP., Taipei City (TW)

(21) Appl. No.: 13/443,031

(22) Filed: Apr. 10, 2012

(30) Foreign Application Priority Data
Apr. 19, 2011 (TW) 100113538

(51) Int. Cl. A47J 43/27; B01F 7/28

(52) U.S. Cl. 366/129

(57) ABSTRACT

A beverage container includes: a pitcher body configured with an inner receiving space for receiving a beverage; an annular lid mounted removably on an open upper end of the pitcher body; an elongate hollow cylinder mounted coaxially and rotatably in the annular lid and configured with an inner accommodating space; a stirring member externally formed on the hollow cylinder; and a plug cap plugged into the hollow cylinder through an open upper end of the hollow cylinder for closing the inner accommodating space in the hollow cylinder.

### CROSS-REFERENCE TO RELATED APPLICATION

This application claims priority to Taiwanese Application No. 100113538, filed on Apr. 19, 2011.

### BACKGROUND OF THE INVENTION

1. Field of the Invention

The invention relates to a container, and more particularly to a beverage container.

2. Description of the Related Art

Referring to FIG. 1, a conventional beverage container 9 with cooling and stirring structures disclosed in U.S. Pat. No. 5,472,274 is shown to include a pitcher body 91, a pitcher lid 92, a cooling cylinder 93, and a stirring rod 94. The pitcher body 91 is configured with an inner receiving space 911 for receiving a beverage (not shown). The pitcher lid 92 is removably coupled to an open top end of the pitcher body 91 . The cooling cylinder 93 is mounted in the pitcher lid 92, extends into the inner receiving space 911 in the pitcher body 91, and contacts the beverage in the pitcher body 91. The cooling cylinder 93 includes a tube body 930 configured with an inner accommodating space 931 for receiving a plurality of ice cubes (not shown), and a cap body 933 mounted removably in the pitcher lid 92 and connected detachably to an open top end of the tube body 930 for closing the tube body 930. The stirring rod 94 extends through the pitcher lid 92 into the inner receiving space 911.

In such a configuration, due to the ice cubes in the tube body 930, the beverage contained within the pitcher body 91 can be rapidly cooled by the cooling cylinder 93. In addition, sediments in the beverage can be stirred up through agitation by the stirring rod 94.

However, since the cooling cylinder 93 and the stirring rod 94 are mounted in the pitcher lid 92 and are close to each other, an agitation range of the stirring rod 94 is limited by the tube body 930 of the cooling cylinder 93, thereby resulting in a poor stirring effect. Besides, when the ice cubes are filled into the tube body 930 of the cooling cylinder 93, the pitcher lid 92 must be removed from the pitcher body 91 while the tube body 930 must be removed from the cap body 933, thereby resulting in inconvenience during use.

### SUMMARY OF THE INVENTION

Therefore, an object of the present invention is to provide a beverage container that can overcome the aforesaid drawbacks of the prior art.

According to the present invention, the beverage container includes a pitcher body, an annular lid, an elongate hollow cylinder, a stirring member, and a plug cap.

The pitcher body is configured with an inner receiving space adapted for receiving a beverage therein. The pitcher body has an open upper end.

The annular lid is mounted removably on the open upper end of the pitcher body.

The elongate hollow cylinder is mounted coaxially in the annular lid, extends into the pitcher body to contact the beverage in the pitcher body, and is rotatable relative to the annular lid about a central axis thereof. The hollow cylinder has a closed lower end disposed in the inner receiving space in the pitcher body, and an open upper end coupled rotatably to the annular lid. The hollow cylinder is configured with an inner accommodating space.

The stirring member is externally formed on the hollow cylinder and is disposed in the inner receiving space in the pitcher body.

The plug cap is plugged into the hollow cylinder through the open upper end of the hollow cylinder for closing the inner accommodating space in the hollow cylinder.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic sectional view showing a conventional beverage container;

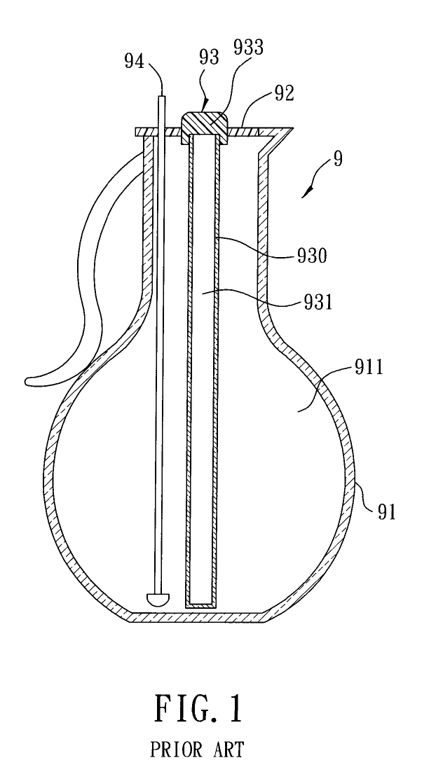

FIG. 2 is an exploded perspective view showing the first preferred embodiment of a beverage container according to the present invention;

FIG. 3 is a schematic sectional view showing the first preferred embodiment when in a state of use;

FIG. 4 is an enlarged fragmentary schematic sectional view showing the first preferred embodiment; and

FIG. 5 is a schematic sectional view showing the second preferred embodiment of a beverage container according to the present invention when in a state of use.

### DETAILED DESCRIPTION OF THE PREFERRED EMBODIMENTS

Before the present invention is described in greater detail, it should be noted that like elements are denoted by the same reference numerals throughout the disclosure.

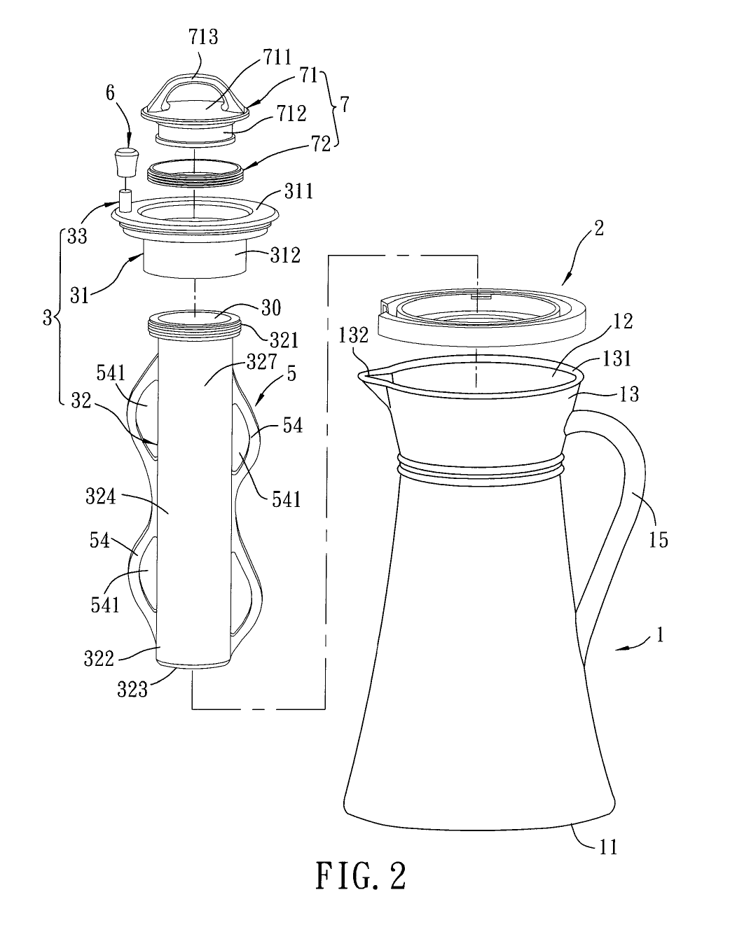

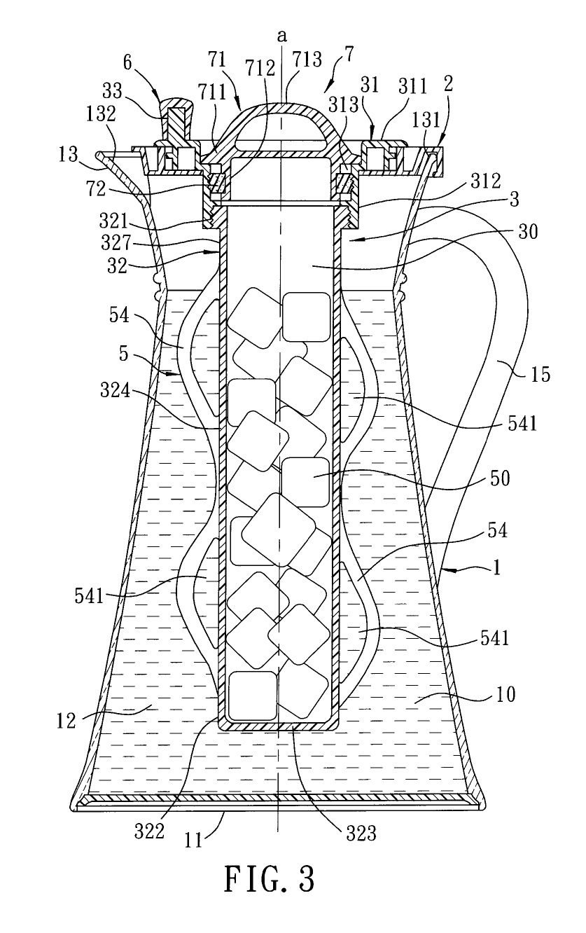

Referring to FIGS. 2 and 3, the first preferred embodiment of a beverage container of the present invention is shown to include a pitcher body 1, an annular lid 2, an elongate hollow cylinder 3, a stirring member 5, and a plug cap 7.

The pitcher body 1 is configured with an inner receiving space 12 adapted for receiving a beverage 10, such as water, milk, coffee, tea, wine, etc. therein (see FIG. 3). The pitcher body 1 has a bottom side 11, a handle 15, and an annular upper edge 131 defining an open upper end 13 of the pitcher body 1. The annular upper edge 131 is shaped so as to define an exposed pouring spout 132 such that the beverage 10 is poured out of the pitcher body 1 through the pouring spout 132. In this embodiment, the pitcher body 1 is made of a transparent material but the invention is not limited in this respect.

The annular lid 2 is mounted removably on the open upper end 13 of the pitcher body 1.

The hollow cylinder 3 is mounted coaxially in the annular lid 2, and extends into the pitcher body 1 to contact the beverage 10 in the pitcher body 1. The hollow cylinder 3 is rotatable relative to the annular lid 2 about a central axis (a) thereof. The hollow cylinder 3 has a closed lower end disposed in the inner receiving space 12 in the pitcher body 1, and an open upper end coupled rotatably to the annular lid 2. The hollow cylinder 3 is configured with an inner accommodating space 30 (see FIG. 3) . In this embodiment, the hollow cylinder 3 includes an annular connecting seat 31, a tube body 32, and an operating rod 33, wherein the annular connecting seat 31 and the tube body 32 are respectively formed as individual parts. In other embodiments, the annular connecting seat 31, the tube body 32, and the operating rod 33 can be integrally formed as a single part.

The annular connecting seat 31 has an enlarged upper end portion 311 that serves as the open upper end of the hollow cylinder 3 and that is positioned rotatably on the annular lid 2, and an internally threaded lower end portion 312 that extends downward out of the annular lid 2.

The tube body 32 has a closed lower end 322 that serves as the closed lower end of the hollow cylinder 3, and an externally threaded open upper end 321 that extends into and is threadedly connected to the lower end portion 312 of the annular connecting seat 31. The tube body 32 has a bottom wall 323, and an annular surrounding wall 324 extending upward from a periphery of the bottom wall 323 and cooperating with the bottom wall 323 to define the inner accommodating space 30 in the hollow cylinder 3. The annular surrounding wall 324 has an annular outer surface 327.

The operating rod 33 extends upward from the enlarged upper end portion 311 of the annular connecting seat 31. Preferably, an anti-slip cover 6 is mounted fittingly on the operating rod 33 to facilitate operation of the operating rod 33.

The stirring member 5 is externally formed on the hollow cylinder 3, and is disposed in the inner receiving space 12 in the pitcher body 1. In this embodiment, the stirring member 5 includes, but is not limited to, a plurality of spaced apart two stirring fins 54. Each stirring fin 54 extends outward from the annular outer surface 327 of the annular surrounding wall 324 of the tube body 32 of the hollow cylinder 3, and is formed with a plurality of through holes 541.

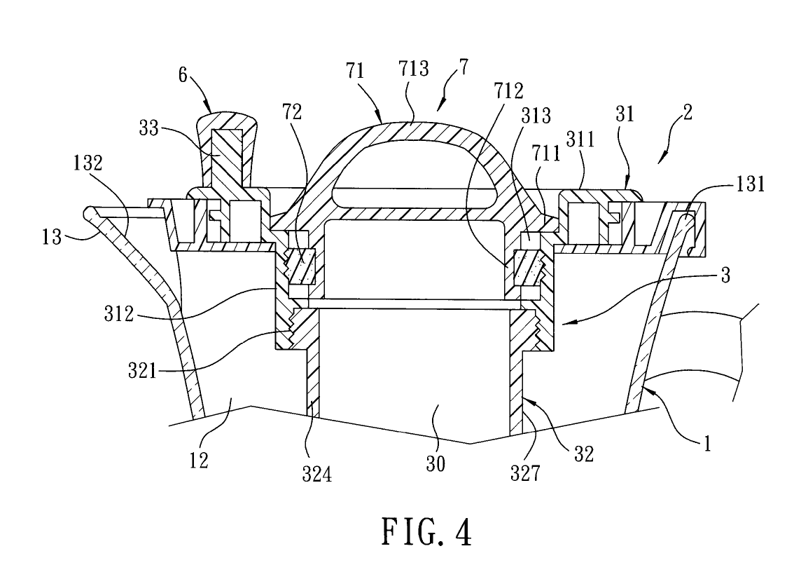

The plug cap 7 is plugged into the hollow cylinder 3 through the open upper end of the hollow cylinder 3 for closing the inner accommodating space 30 in the hollow cylinder 3. In this embodiment, the plug cap 7 includes a cap body 71, and an O-ring seal 72. The cap body 71 has an enlarged head portion 711 and a plug portion 712. The enlarged head portion 711 is disposed in the upper end portion 311 of the annular connecting seat 31. The plug portion 712 is opposite to the head portion 711 and extends into the lower end portion 312 of the annular connecting seat 31. Preferably, a grip rod 713 is formed integrally on the enlarged head portion 711 of the cap body 71 to facilitate removal of the cap body 71 from the connecting seat 31 of the hollow cylinder 3. The O-ring seal 72 is sleeved on the plug portion 712 of the cap body 71 for sealing a space 313 between the plug portion 712 of the cap body 71 and the lower end portion 312 of the annular connecting seat 31, as best shown in FIG. 4. In this embodiment, the O-ring seal 72 is made of rubber or silicone.

In use, as shown in FIG. 3, the inner accommodating space 30 in the hollow cylinder 3 is filled with a plurality of ice cubes 50 as a heat exchanging medium. As such, the beverage 10 in the pitcher body 1 is cooled. In other embodiments, the heat exchanging medium can be hot water to heat the beverage 10 in the pitcher body 1. When it is desired to add more ice cubes into the inner accommodating space 30 in the hollow cylinder 3, filling of the ice cubes into the inner accommodating space 30 in the hollow cylinder 3 can be done after removal of the plug cap 7 from the hollow cylinder 3. Therefore, usage of the beverage container of the present invention is convenient compared to the aforesaid conventional beverage container. On the other hand, when the operating rod 33 is manually operated to rotate an assembly of hollow cylinder 3 and the plug cap 7 relative to the annular lid 2 about the central axis (a) , the stirring member 5 rotates with the hollow cylinder 3. In this case, sediments in the beverage 10 can be stirred up through agitation by the stirring member 5. Therefore, uniform agitation by the stirring member 5 can be achieved in the inner receiving space 12 in the pitcher body 1, thereby resulting in a superior stirring effect.

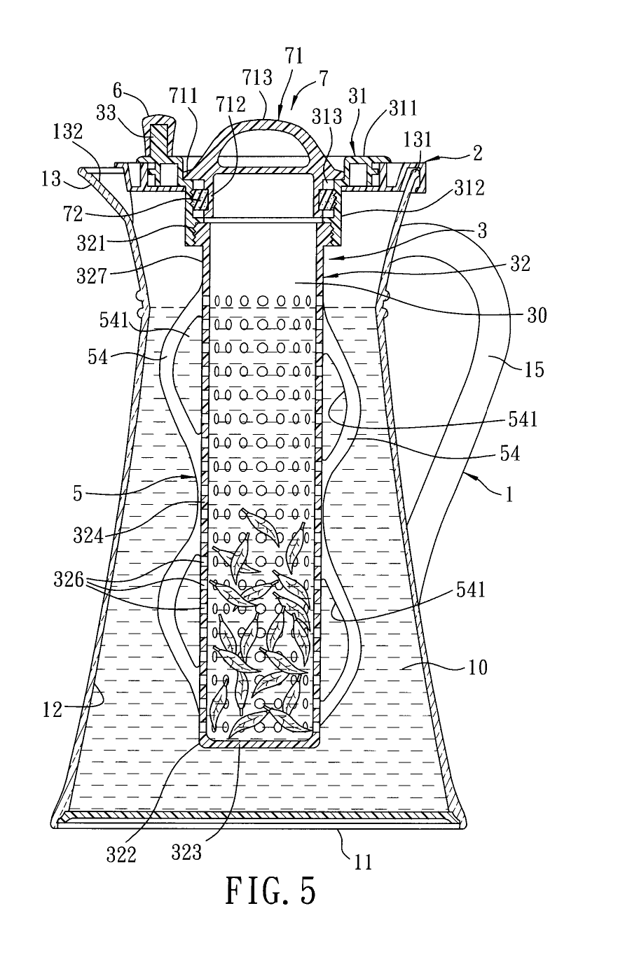

FIG. 5 shows the second preferred embodiment of a beverage container according to this invention, which is a modification of the first preferred embodiment. In this embodiment, the annular surrounding wall 324 of the tube body 32 of the hollow cylinder 3 is formed with a plurality of filter holes 326 in spatial communication with the inner accommodating space 30 such that the beverage 10, for example water, enters the inner accommodating space 30 in the hollow cylinder 3 through the filter holes 326. In addition, for example, the hollow cylinder 3 is used to accommodate tea leaves therein such that the tea leaves contained in the inner accommodating space 30 in the hollow cylinder 3 are immersed in the beverage 10. After a while, a tea drink is thus made. Therefore, the beverage container of the present invention can serve as a tea maker for making different kinds of tea drinks.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A beverage container comprising:
a pitcher body configured with an inner receiving space adapted for receiving a beverage therein, said pitcher body having an open upper end;
an annular lid mounted removably on said open upper end of said pitcher body;
an elongate hollow cylinder mounted coaxially in said annular lid, extending into said pitcher body to contact with the beverage in said pitcher body, and rotatable relative to said annular lid about a central axis thereof, said hollow cylinder having a closed lower end disposed in said inner receiving space in said pitcher body, and an open upper end coupled rotatably to said annular lid, said hollow cylinder being configured with an inner accommodating space;
a stirring member externally formed on said hollow cylinder and disposed in said inner receiving space in said pitcher body; and
a plug cap plugged into said hollow cylinder through said open upper end of said hollow cylinder for closing said inner accommodating space in said hollow cylinder.

2. The beverage container as claimed in claim 1, wherein said hollow cylinder includes:
an annular connecting seat having an enlarged upper end portion that serves as said open upper end of said hollow cylinder and that is positioned rotatably on said annular lid, and an internally threaded lower end portion extending downward out of said annular lid; and
a tube body having a closed lower end that serves as said closed lower end of said hollow cylinder, and an externally threaded open upper end extending into and threadedly connected to said lower end portion of said annular connecting seat.

3. The beverage container as claimed in claim 2, wherein said tube body of said hollow cylinder has a bottom wall, and an annular surrounding wall extending upward from a periphery of said bottom wall to define said inner accommodating space in said hollow cylinder, said annular surrounding wall having an annular outer surface provided with said stirring member thereon.

4. The beverage container as claimed in claim 3, wherein said annular surrounding wall of said tube body of said hollow cylinder is formed with a plurality of filter holes in spatial communication with said inner accommodating space.

5. The beverage container as claimed in claim 3, wherein said plug cap includes:
a cap body having an enlarged head portion disposed in said upper end portion of said annular connecting seat, and a plug portion opposite to said head portion and extending into said lower end portion of said annular connecting seat; and
an O-ring seal sleeved on said plug portion of said cap body for sealing a space between said plug portion of said cap body and said lower end portion of said annular connecting seat.

6. The beverage container as claimed in claim 3, wherein said stirring member includes a plurality of spaced apart stirring fins each extending outward from said annular outer surface of said annular surrounding wall of said tube body of said hollow cylinder and formed with a plurality of through holes.

7. The beverage container as claimed in claim 1, wherein said hollow cylinder further includes an operating rod extending upward from said open upper end and operable to rotate an assembly of said hollow cylinder and said plug cap.

8. The beverage container as claimed in claim 1, wherein said pitcher body has an annular upper edge defining said open upper end and shaped so as to define an exposed pouring spout.
